(19) United States
(12) Patent Application Publication
(10) Pub. No.: US 2005/0027633 A1
(43) Pub. Date: Feb. 3, 2005

(54) Application and processes for the review and adjustment of the full lifecycle of consumer finances

(76) Inventors: Joey Fortuna, Washington, DC (US); Michael Kiefer, Frederick, MD (US); Philip L. Shen, Chevy Chase, MD (US); Ramesh Vishnubhatla, Sterling, VA (US); David Mashburn, Rockville, MD (US); George Fortuna, Braddock Heights, MD (US)

Correspondence Address: KOESTNER BERTANI, LLP, P.O. BOX 26780, AUSTIN, TX, 78755, US

(21) Appl. No.: 10/877,817

(22) Filed: Jun. 25, 2004

Related U.S. Application Data
(60) Provisional application No. 60/482,489, filed on Jun. 25, 2003.

(51) Int. Cl. G06F 17/60

(52) U.S. Cl. 705/36

(57) ABSTRACT

A network based system to facilitate managing a consumer's financial development. This network based system includes at least one computer system operable to execute a consumer module, a communication module, a lead sourcing module, a creditor module, a financial processing module, and a counselor module. A number of databases such as a consumer database, creditor database, and lead database operably couple to the network based computer. Consumers, counselors and creditors may interact with one another through web-based user interfaces presented by modules executed on the network based computer.

### CROSS-REFERENCE TO RELATED APPLICATION

This application claims the benefit of priority to U.S. Provisional Patent Application No. 60/482,489 entitled “Application and Processes for the Review and Adjustment of the Full Lifecycle of Consumer Finances”, filed on Jun. 25, 2003, and is incorporated herein by reference in its entirety.

### TECHNICAL FIELD OF THE INVENTION

The present invention relates generally to financial management in the field of credit and debt adjustment systems and methods, and more particularly, a system and method for counseling, reporting on the nature of, and improving the status and condition of consumer finances.

### BACKGROUND OF THE INVENTION

The current finance and credit counseling industry comprises hundreds of individual homegrown methods developed by parties that represent various points along the lifespan of a consumer's financial condition. Since each party works within specific areas that fall within their specific expertise, the methods and practices associated with their homegrown methods are non-standard and often both incomplete and incompatible. Additionally, since the various methods are employed at different stages in the consumer's financial development, few efforts are made to ensure the consistency and availability of information throughout the different stages of a consumer's financial development. Where solutions do exist that span different stages of the consumer's financial development, these solution are too general and/or imprecise to satisfy the particular needs of the parties that employ them.

A need exists to provide a uniform set of tools, which can be employed as a combined unit to monitor, counsel for, and improve upon the state of consumer finances throughout all stages of a consumer's financial development. Such a solution encourages consumers to retain their information in the same repository or database throughout all stages of their financial development.

### SUMMARY OF THE INVENTION

The present invention provides a combination of human and technical systems that substantially address the above identified needs. More specifically, the present invention eliminates or reduces disadvantages and problems associated with previously developed incompatible, purely technical, or purely human systems and methods used for financial counseling and review.

This disclosure teaches a system that allows consumers to self-monitor and self-manage their own financial growth. This system includes an Internet interface for consumers and Agency personnel (counselors, managers), customer service desktop management tools, CRM software for the review and analysis of consumer trends, CRM software for the maintenance and integration of agency-to-consumer communication (and vice-versa), human processes for the provision of ongoing consumer relations and to supplement data entry.

The disclosure provides a complex matrix of checks and balances to ensure complete data integrity throughout the lifespan of a consumer's financial record. These checks and balances include a partnership between automated systems and human intervention. A unifying framework within which a consumer financial record may be stored and moved from state to state allows previously incompatible software tools to utilize common information. The common unifying framework accessible through the Internet or other like network allows universal access.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates data flow within existing systems;

FIG. 2 illustrates the data flow within an embodiment of the present invention;

FIG. 3 provides a logic-flow diagram of the end-to-end structure contained in this disclosure indicating how consumer information passes from the point of capture to the point of credit resolution;

FIG. 4 illustrates the numerous modules and databases associated with the present invention;

FIG. 5 illustrates a screen shot from one potential embodiment of the consumer enrollment interface;

FIG. 6 provides a second screen shot of the consumer enrollment interface;

FIG. 7 provides a third screen shot from the consumer enrollment interface;

FIG. 8 provides a fourth screen shot from the consumer enrollment interface;

FIG. 9 provides a fifth screen shot from the consumer enrollment process associated with the present invention;

FIG. 10 provides a screen shot illustrating many resources available to consumer;

FIG. 11 provides a comparison of debt reduction using a debt management plan facilitated by the present invention and an unfacilitated debt reduction;

FIG. 12 provides a logic-flow associated with the communication module of one embodiment of the present invention;

FIG. 13 provides a screenshot associated with the creditor module of the present invention;

FIG. 14 provides a second screenshot associated with the creditor module of the present invention;

FIG. 15 provides a screen shot associated with the creditor module;

FIG. 16 provides a screen shot associated with the lead sourcing module;

FIG. 17 provides a screen shot associated with undistributed leads;

FIG. 18 provides a screen shot associated with distributed leads;

FIG. 19 provides a screen shot associated with ineligible leads;

FIG. 20 provides a screen shot associated with the counselor module;

FIG. 21 provides a screen shot again associated with counselor module;

FIG. 22 provides a logic flow diagram associated with the topics associated with the counselor interview of a consumer;

FIG. 23 provides the logic flow of the end-to-end structure contained in this disclosure indicating how consumer information passes from the point of capture to the point of credit resolution; and

FIG. 24 shows the partnership between automation and human intervention provided by the instant application.

### DETAILED DESCRIPTION OF THE INVENTION

Preferred embodiments of the present invention are illustrated in the FIGURES, like numerals being used to refer to like and corresponding parts of the various drawings.

This disclosure provides a process, which facilitates lifelong insight into the path of consumers who are seeking to improve their credit and credit scores. A system is provided that allows consumers with or without the aide of counselors to monitor and manage their own financial growth and development. This includes an internet interface for both consumers and agency personnel, customer service desktop tools, software for the review and analysis for consumer trends, software for the maintenance and integration of agency to consumer communications, and processes that provision ongoing consumer relations and to supplement data entry.

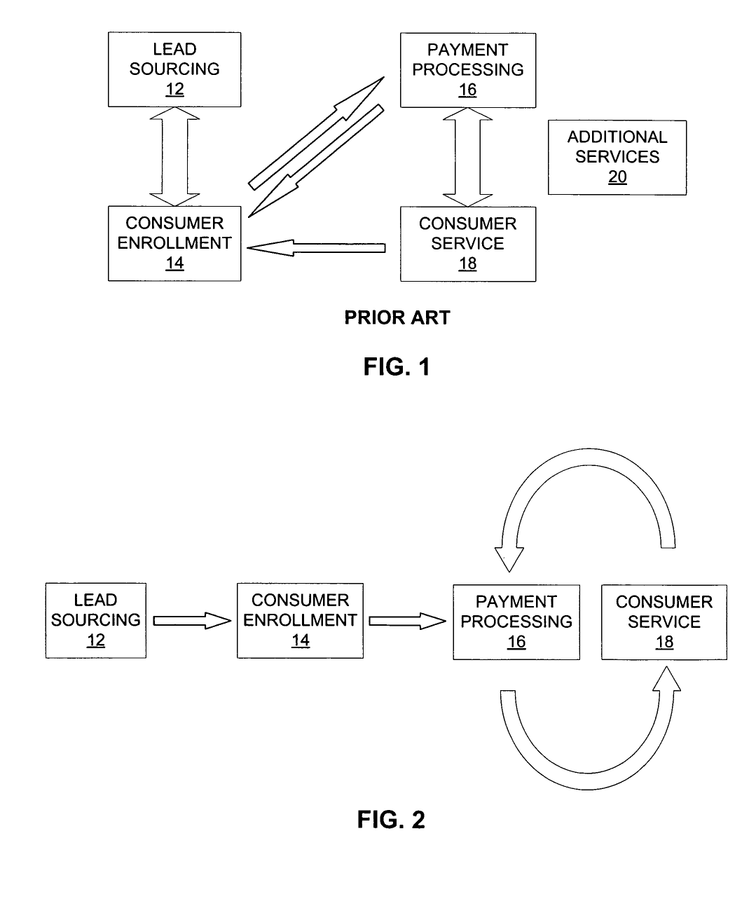

FIG. 1 shows how data flowed within previously developed systems. Here lead 12 was developed and used to prompt consumer enrollment for team. This consumer enrollment would follow and result in payment processing 16 and customer service 18. Additional services 20 would be provided outside of these payment and customer services. Additionally, any additional consumer enrollment would be required for new services throughout the consumer's financial development.

However, within the present invention, the flow of data may be described by FIG. 2. Here lead sourcing 12 results in initial consumer enrollment 14. This results in ongoing payment processing 16 and consumer service 18 that directly work to improve consumer experience. However, unlike the prior systems which would require enrollment throughout the consumer's financial development, the present invention provides an iterative process wherein consumer service may continually service and expand throughout the consumer's financial development without requiring the repetitive entry of common data.

The Internet interface for consumers and agency personnel allows consumers to enroll and maintain their accounts. For example, a consumer may sign up over the internet using a form to produce a lead. Additionally, based on the profile that they are providing, the consumer may review their own account or profile and make changes as necessary. As consumers have become more familiar with the process of self-managed finances, the need and desire for automatic enrollment is addressed. Therefore, the present invention presents a more user friendly, consumer centered vision of lead management that will be discussed in additional modules associated with the present invention. Consumers may qualify, educate, and enroll themselves in services offered by the processor agency.

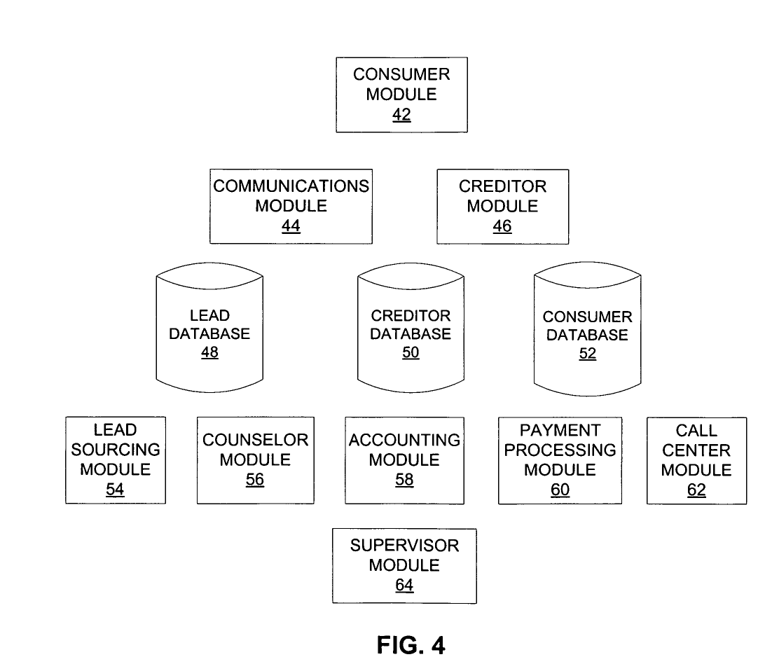

FIG. 4 depicts various modules and databases associated with the present invention. These include but are not limited to consumer module 42, communications module 44, creditor module 46, leads database 48, creditor database 50, consumer database 52, lead sourcing module 54, counselor module 56, accounting module 58, payment processing module 60, call center module 62 and supervisor module 64. The functions and purposes of these various modules will be discussed with further detail.

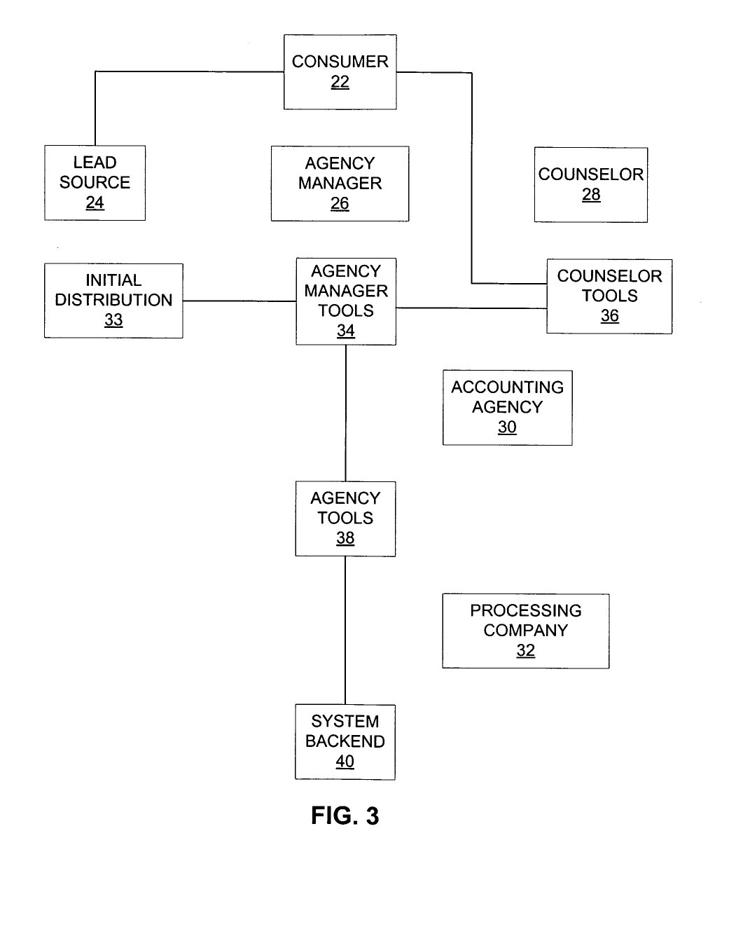

FIG. 3 illustrates one embodiment of the processes from end-to-end. Consumer 22 is received from a lead source 24 and distributed within the system as a lead. This information is provided to an agency manager 26 which has an available tool set of agency manager tools 34. Tools 34 are linked with counselor tools 36 and agency accounting tools 38, which are managed by a system back end.

Consumer 22 may sign up through a network such as the Internet using a web-based form to generate lead source 24. Consumer 22 can review their account or profile and make changes with counselor tools 36.

Lead Source 24 provides a mechanism in which leads are transferred directly to an agency. Agency manager 26 may assign lead to counselors 28. Agency manager 26 may use information to rate lead sources 24 as well as counselors 28 and to individually and statistically track and report leads, consumers, counselors and their interactions.

Counselor 28 encourages Consumer 22 to enroll within various programs. Counselor 28 may generate and distribute documents for Consumer 22 to indicate the consumers' status. Accounting agency 30 receives, enters, manages and schedules payments and generates internal reports with which counselors can claim these payments. Processing company 32 provides the backend support to support and manages consumers, agencies, counselors and their interactions with these tools and reports. These may include the ability to generate reports, view documents, disburse payments, and manage payment and billing functions.

FIG. 4 depicts various modules and databases associated with the present invention. These include but are not limited to consumer module 42, communications module 44, creditor module 46, leads database 48, creditor database 50, consumer database 52, lead sourcing module 54, counselor module 56, accounting module 58, payment processing module 60, call center module 62 and supervisor module 64. The functions and purposes of these various modules will be discussed with further detail.

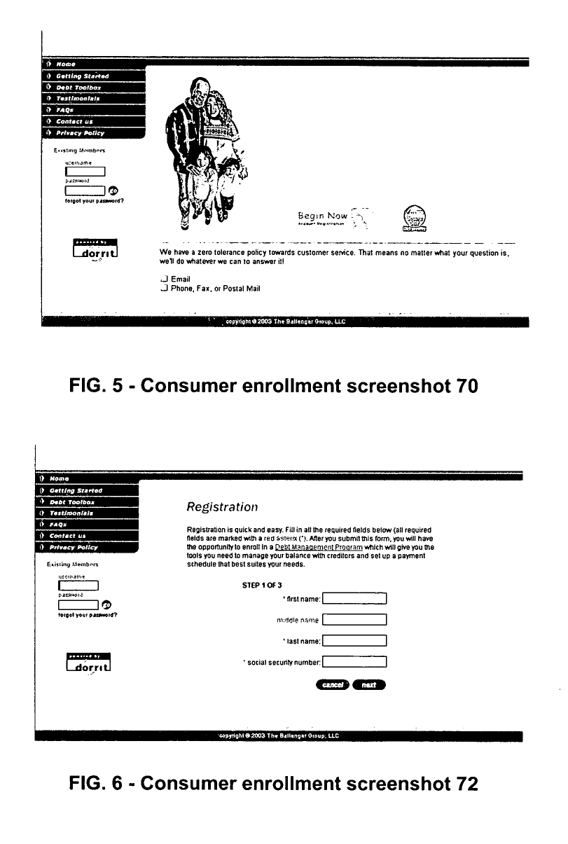

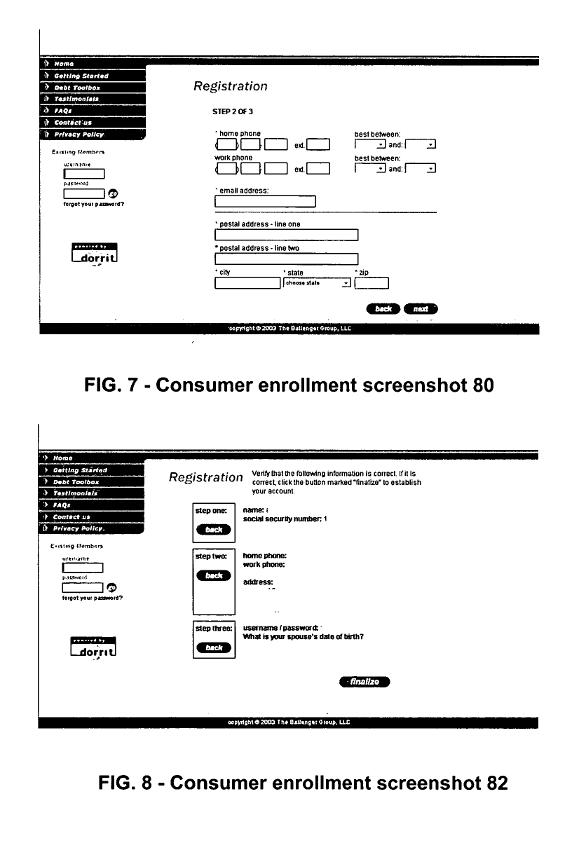

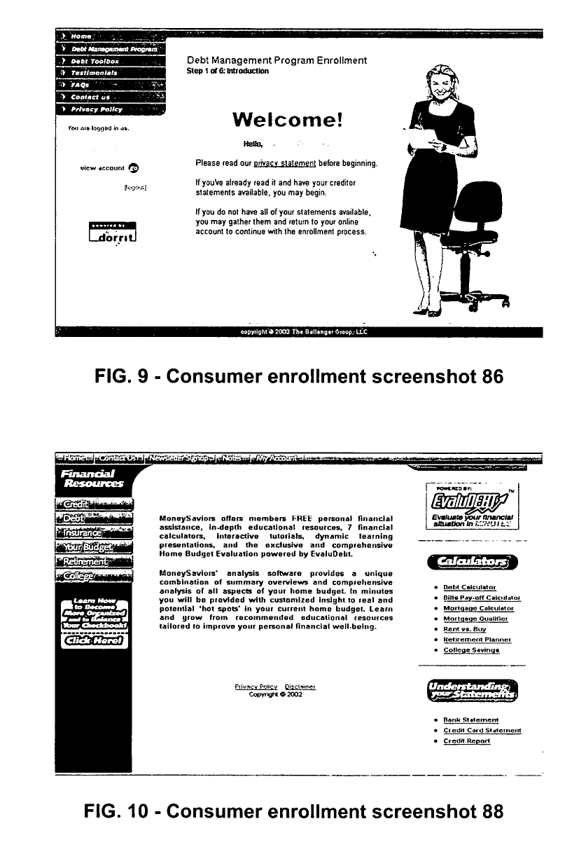

Consumer modules 42 may be broken into two main components: consumer enrollment and consumer account maintenance. FIGS. 5 through 10 provide screen shots from one embodiment of the consumer web interface. This interface allows consumers to register themselves directly through the Internet. The process involves initial registration, and access to some diagnostic tools and budget calculators. Following initial registration, the consumer is prompted to enroll in a debt management program. This process culminates in a complete consumer application (pending counselor validation). The screen shots provided prompt the consumer to continue with XML-based communication or other like communications. FIG. 5 provides an initial consumer enrollment screen shot 70 with which to begin the process. The screen shots serve as an introduction to the registration and consumer enrollment process. Screen shot 72, provided in FIG. 6, begins actual registration wherein a consumer completes required fields 74. Existing consumers may log in directly with a user ID and password supplied through fields 76 and 78. Consumer enrollment screen shot 80 and 82 of FIGS. 7 and 8 respectively, allow the user to complete additional fields and confirm or verify the supplied information. Once enrollment is completed, as illustrated in the consumer enrollment screen shot 86 provided within FIG. 9, additional financial resources and calculators may be provided as indicated in screen shot 88 of FIG. 10.

After completing enrollment, whether the consumer is enrolled through their own actions or with the aid of a counselor, the consumer may then edit and view several aspects of their own account information within the maintenance section. Additionally consumers may have the ability to review the status of items such as proposal letters to creditors that propose an adjusted payment plan and the ability to track these proposals within the consumer's account. Consumers may track and review proposed transactions. During the proposal period, the transaction may specifically track whether or not the proposal within the above-identified letter is rejected or accepted and when the response is due from the creditor.

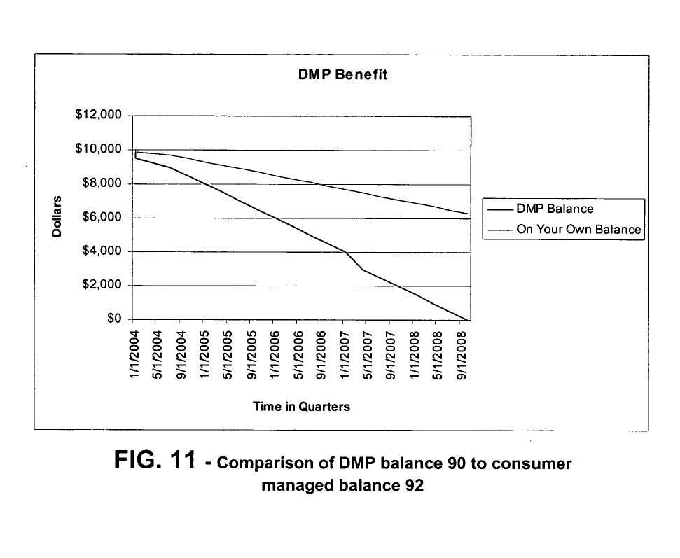

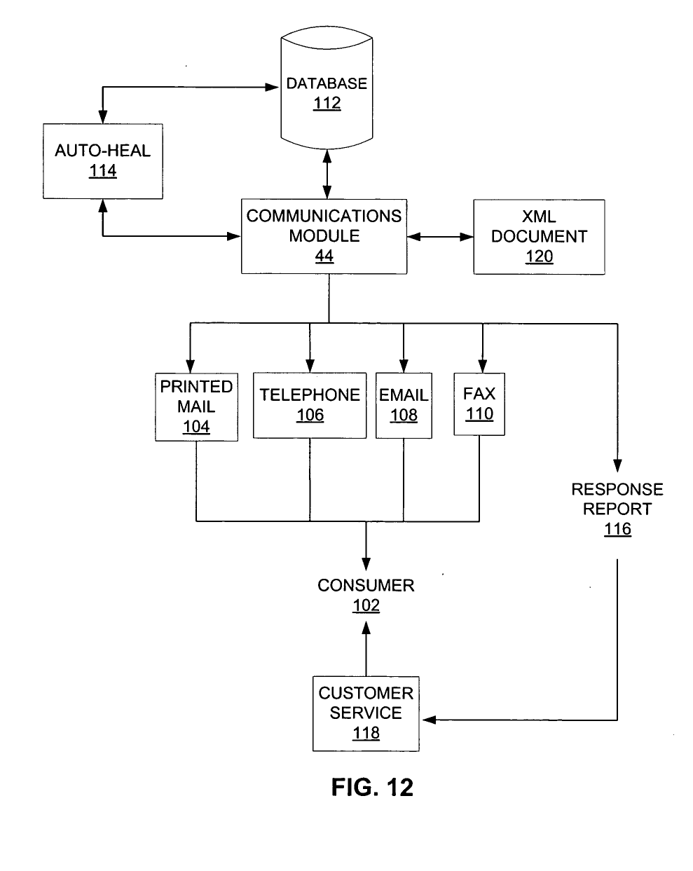

Consumers may also visualize their debt management plan (DMP), savings, progress and payoff time frames. Consumers may track their expected progress using the DMP and expected savings as shown in FIG. 11. FIG. 11 tracks the outstanding balance of a single debt with and without a DMP over several quarters and compares the progress curve 90 and curve 92, respectively.

Consumer maintenance may also allow the consumer to track their payment options. Funds may be automatically withdrawn from a checking or savings account using electronic funds transfer (EFT) for creditors. This avoids the inconvenience associated with monthly payments, and removes the difficulties associated with making payments, and helps consumers to organize their finances. This option alone may save consumers hundreds of thousands of dollars compared to conventional means. Communications module 44 provides a means of maintaining effective consumer service standards. This involves issuing periodic messages to the consumers. These messages may take many forms, including requests for additional information, reminders about coming due dates, alerts, information related to policy changes and other like information known to those skilled in the art. Users may trigger on-demand communications when necessary. Examples of such necessary communications may include the deliver of application materials within the counselor module 56 or lead management interface 54. Alternatively, scheduled communications or recurring communications may be sent to consumers both as triggered by users of the system and in accordance with back-end logic. Examples of recurring or scheduled communications may include monthly statements, payment reminders, notices, or other like reminders known to those skilled in the art.

Each consumer record contains information regarding the available and preferred method of communication pertaining to that specific consumer. Based on this communication, communication module 44 may attempt to communicate with the consumer.

FIG. 11 provides a logical diagram indicating the various ways in which Communications.Module 44 may attempt to communicate with a consumer. Here, consumer 102 may communicate with the communications module 44 via several methods of communication including, but not limited to, printed mail 104, telephone service 106, email 108 or fax 110. Consumer records are maintained within database 112. Autoheal module 114 contains a collection of algorithms that harvest rejected communications and use rejected communications as an input for correcting consumer information contained within Database 112. For example, if an email is returned as undeliverable, a telephone call or postal letter is sent to consumer 102 announcing that the system does not have a valid or other contact information, and requests the Response Report 116 provided to consumer 102 via customer service or other communications means in an attempt to correct or heal the consumer records contained within database 112. To correct the consumer records, consumer 102 may be prompted to contact customer service 118 or interface with the consumer database and update their profile via an XML document provided via a web interface.

FIG. 11 depicts the logical flow of one embodiment's XML-based communication engine. This engine operates for the processor on behalf of the agencies. Certain criteria for consumer response are fed into the communication engine through a processor interface. The communication engine then draws a subset of data, determined by the criteria entered above.

The engine cycles through the subset, identifying consumers' preferred means of communication. If that method is available, the engine generates a document eliciting the desired response from the consumer. If the method of communication is unavailable, the communication engine attempts to contacts the consumer through any other method available, while simultaneously prompting the user to correct her information so that the preferred method will be available for future communications.

The communication engine then generates reports, which outline the level of consumer response (or lack thereof). Such reports contain contact information, which may then be utilized by the customer support staff to continue the efforts to elicit consumer response.

FIG. 11 is best described in the context of a marketing effort wherein data is extracted via the communication engine in order to establish contact between counsellors or other customer service agents and individual consumers. The data within the database is used to establish a communication pathway, either via printed postal mail, auto-dialling via the telephone, email or fax. For a large number of the attempted contacts, a bounce-back or other non-responsive form of non-response will be received from the consumer. This indicates a problem with the contact information. Scripts running in the background process these bounce-backs. These scripts force the communication engine to attempt to establish communications with the consumer via another pathway. When this communication is established, a communication engine prompts the consumer to provide the current information. This ensures that the data within the database is automatically corrected and updated. Thus, any bad data within the database is automatically identified and corrected.

Creditor module 46 contains a central database of creditors, which includes all of the benefits, contact information, and associated correspondence pertaining to each creditor with whom the processor, or one of the processor's client agencies, have done business. Creditor module 46 provides a mechanism for maintaining the creditor database 50 and ensuring that all of the data contained therein is up-to-date, and that all of the creditors associated with consumers are correct and accurately recorded.

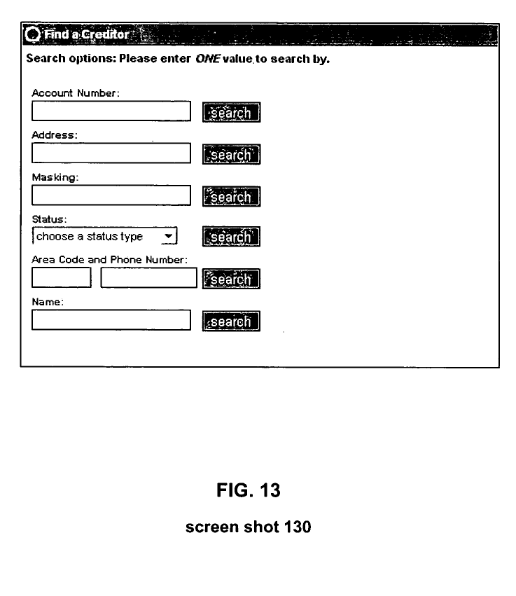

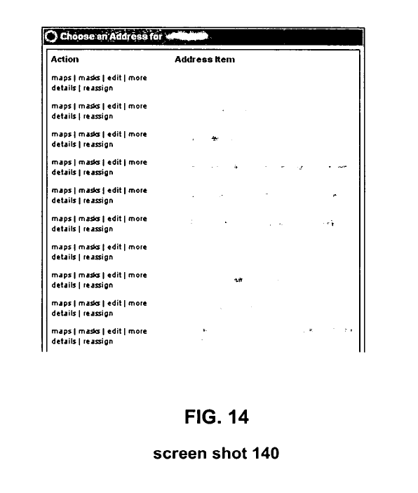

As with many of the other modules, the essential entry point for creditor module 46 is a search function. Using this search function, creditor maintenance personnel (as well as users of other enabled types) can search for creditors within the database using any of a number of search criteria. FIG. 13 provides a screen shot 130 that allows the user to perform an initial search for the parent creditor record (each creditor can have multiple billing addresses, etc.) Often, multiple creditors match the same criteria. In that case, the user will be prompted to choose from among them. All matching addresses for a creditor appear in the search results screen shot 140 of FIG. 14. From screen 140, the user can edit creditor information, reassign one or all instances of a creditor to the users currently assigned, or switch said assignment.

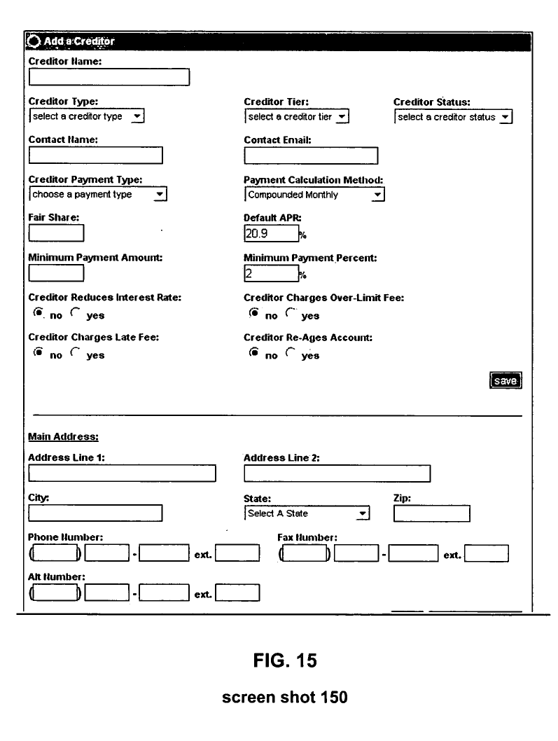

Creditors may be added using a simple form as illustrated with screen shot 150 of FIG. 15, or with the “lead management” utility and the “add consumer” utility (described with reference to counselor module 56), as it is often appropriate to insert creditor information at the time of consumer enrollment. However, all creditors added through either method are still subject to creditor verification. A verify creditors tool allows users with the proper access to examine all inactive creditors currently within the database. These can be creditors entered by a counselor at the time of enrollment, or creditors subsequently entered, but never activated. With this tool, a user can also view active creditors and replace any creditor with another within consumer records, either for a specified instance of that creditor, or all instances.

Lead sourcing module 54 provides means to configure campaigns for lead sourcing, and to capture and report on all leads. Also leads may be distributed to clients who have contracted with the processing company. “Lead” here refers to consumers who have expressed interest in contracting the services of one of the processors clients (agencies). The clients may not be aware of these leads, so the lead source module provides the mechanism for connecting leads and clients.

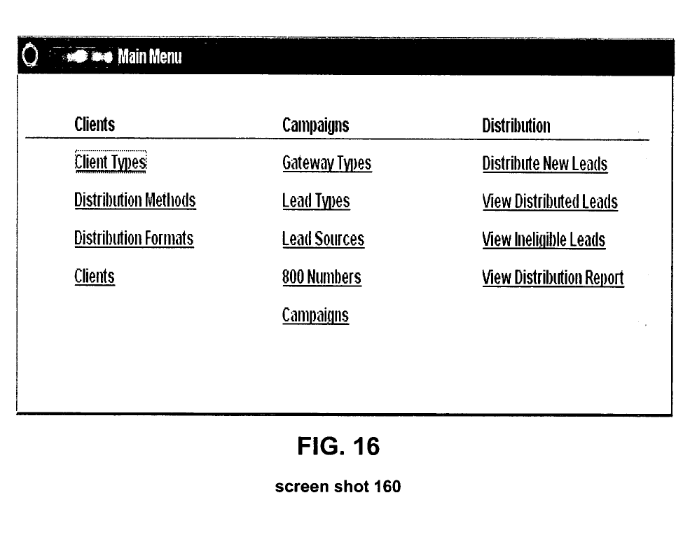

From the menu provided within screen shot 160 of FIG. 16, the user can choose from among any of the interface options available through this module. “Clients” in this context refer to the companies that are contracting the services of the processor. The system is agnostic as to what actual services the clients themselves provide. A client type screen allows a user to configure the system to accept clients of any number of types. Leads can be distributed to clients through a number of different methods. For example a direct transfer of leads from the lead sourcing module to the lead management module may take place or other means such as using email may be used to distribute this information. The distribution may utilize one of many formats. Processor clients may accept leads in any one of a number of formats. These formats can be added to and removed from the system using this interface.

Several items of information are available for each client with whom the processor contracts. In addition to the standard contact information fields, each client can be configured in terms of its hours of operation, distribution formats, distribution methods, as well as any operational restrictions within which the client executes its business. Shown here, as an example, is a configurable list of states within which a client may be forbidden from operating.

The processor contracts with external sources of leads and configures these leads to arrive as part of one or many “Campaigns.” Each campaign can have one or more “lead types” which in turn can have one or more “gateway types.” Leads arrive at the processor through a number of different entry points (termed “gateways”) these include: email, a specific URL, or an 800 number. Any number of gateway types can be added to the system. Gateways and lead types are somewhat linked. For example, a lead type of “known web” will have one or more gateway types of “URL.” The purpose of lead types is to allow for a number of different initiation points of leads to be configured for each campaign.

For example, 800 numbers are a special type of gateway which can be individually activated or deactivated. There are also specific bits of information pertaining to each 800 number, such as whether the number is for incoming or outgoing calls.

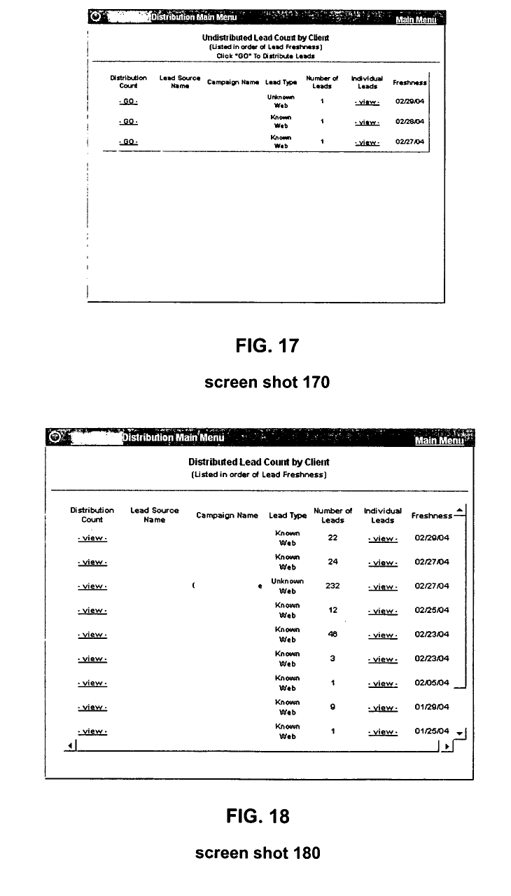

All Leads enter the processor's system through a specific campaign. Additionally, each lead corresponds to an individual lead type, and each lead type assigned to a campaign has one or more active gateways at any given point. Each campaign may be a “standing” campaign (which has no end date) or may be constrained to a specific time period (starting on a given date and ending on another). Screen shot 170 of FIG. 17 provides a menu from which new leads may be distributed.

Screen Shot 170 shows a list of all campaigns 172 for which there are undistributed leads. Clicking the “GO” link takes the user to a list of all clients and presents the user with an entry field in which the user can indicate which clients should receive leads, and how many. Clicking the “view” link allows the user to individually distribute leads to specified clients.

Screen shot 180 of FIG. 18 shows a list of all campaigns for which there are distributed leads. Clicking the “view” link on the left takes the user to a list of all clients and indicates how many leads each client has received (for that campaign) to date and on the day the link is clicked. Clicking the “view” link on the right allows the user to see individual leads, which client they were sent to, and when they were sent.

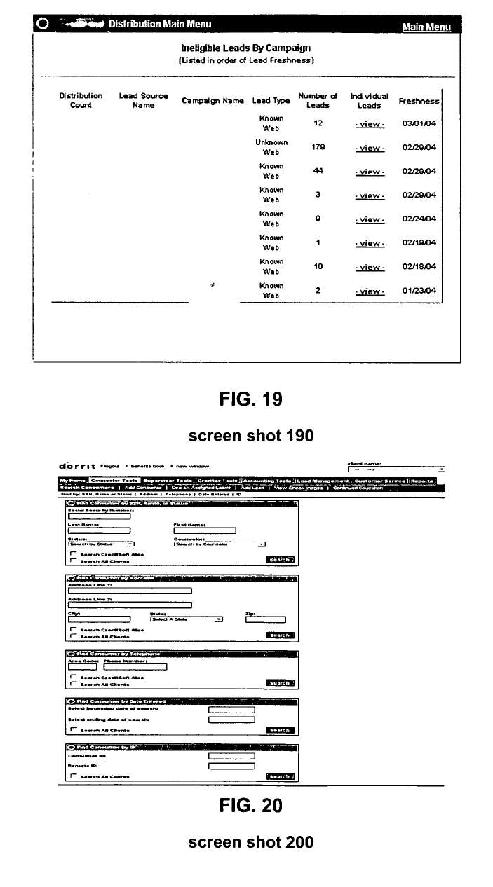

Screen shot 190 of FIG. 19 shows a list of all campaigns for which there are ineligible leads. Clicking the “view” link on the left takes the user to a list of all of the individual leads who are categorized as ineligible.

The final utility available in the lead sourcing module is the array of reports that the user can access to gain insight into the progress of lead sourcing. Counselor module 56 provides all of the functionality necessary for counselors to qualify and enroll consumers, as well as a suite of tools for monitoring the ongoing process of the consumers and to provide continued counseling to the consumers. Leads which come in through the lead sourcing module 54 can be transferred directly to counseling module 56 as part of the leads management utility, thereby providing a constant, unbroken chain of data from the consumer's first stage of interest in counseling to their contact with a counselor. Other modules within the system ensure continuity of data beyond this point.

Counselors can search through the system for consumers using a number of different criteria: name, contact information, status, date of entry, and consumer ID as illustrated by screen shot 200 of FIG. 20. This search is access restricted, according to the counselor's level of access. Ordinary counselors can only search within a list of consumers who have been assigned to them. Supervisor counselors can search within a list of consumers who have been assigned to counselors within their supervisory control. Agency Supervisors can search among all consumers whose accounts are being processed by that agency.

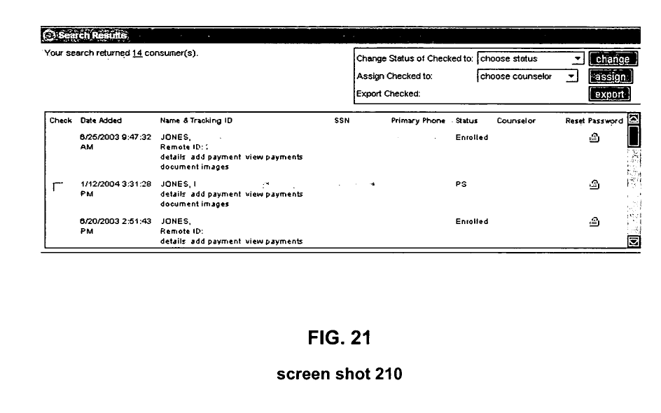

Searching yields a grid of summary information. In the search results screen as illustrated by screen shot 210 of FIG. 21, high-level adjustments can be made to selected groups of consumers. The consumers (as a group) can be assigned a different status, or assigned to different counselors (if the user's access level permits).

Screen shot 200 also includes a “details” link for each consumer which connects the user to a drilled-down view of all of the selected consumer's account details. This is an extensive screen which contains all of the consumer's contact information, budget information, information about all of the consumer's creditor accounts, as well as ledger-type information of the consumer's payment history, payment preferences and other general account information. From the consumer details screen, several types of messages can be sent to the consumer via the communications module. Examples include: letters concerning inadequate or inaccurate information submitted, re-sending application materials, payment address reminders, etc. These messages can be triggered directly from the interface.

From the consumer details screen, all of the imaged documents pertaining to a given consumer are available for viewing.

Although most consumers will enter the system or counselor through the leads management utility, this utility provides a quick way for a user to enter a consumer into the system without qualifying them as a lead. This is not intended for regular use, and is only necessary in case of accidental entry, or data loss.

The leads management utility provides a way for agency administrators to distribute leads to counselors, and for counselors to educate and qualify consumers for the appropriate financial counseling service.

Most leads will enter the system either through automatic import (see the description of the lead sourcing module) or by manual import of third party lead files. Although most consumers will enter the system or counselor through the leads management utility, this utility provides a quick way for a user to enter a consumer into the system without qualifying them as a lead. This is not intended for regular use, and is only necessary in case of accidental entry, or data loss.

Each lead may be associated with a specific lead vendor, and the process of agency configuration begins with the addition of Lead Vendors into the system and the configuration of each vendor.

Once leads are entered into the system (either by manual import, automatic import from the lead sourcing module, or manual entry through the step-by-step process described below), the leads can either be assigned to counselors manually, on an individual lead basis (see below) or they can be automatically assigned according to pre-determined algorithms such as: Even Distribution, Weighted Distribution, etc. All access to lead import, entry, and assignment is restricted in accordance with the user's access rights to the system. Similar to the way that counselors can search for consumers within the system, a facility exists for counselors (and agency administrators) to search for leads.

Users can search according to a number of different criteria, including date entered, date assigned, counselor, spanish speaking flag, status, total debt, name, address, phone number, lead vendor, lead source and failed contact attempts.

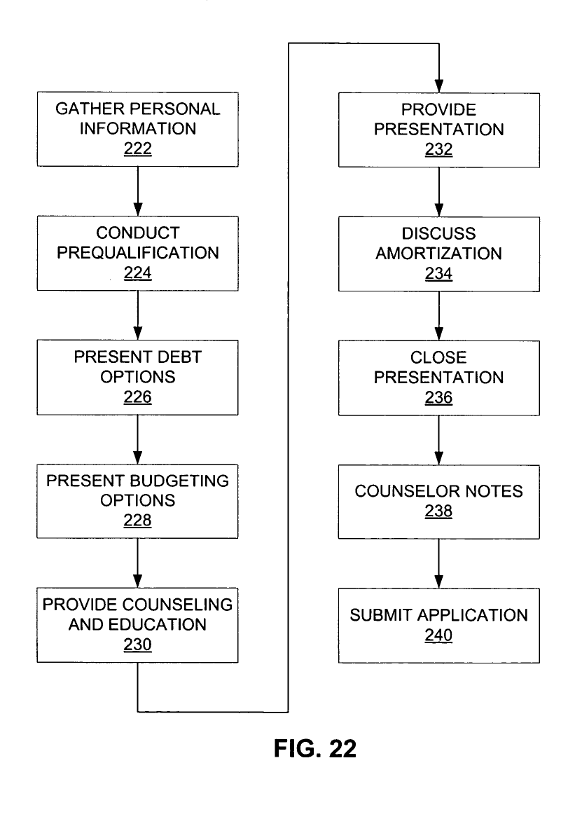

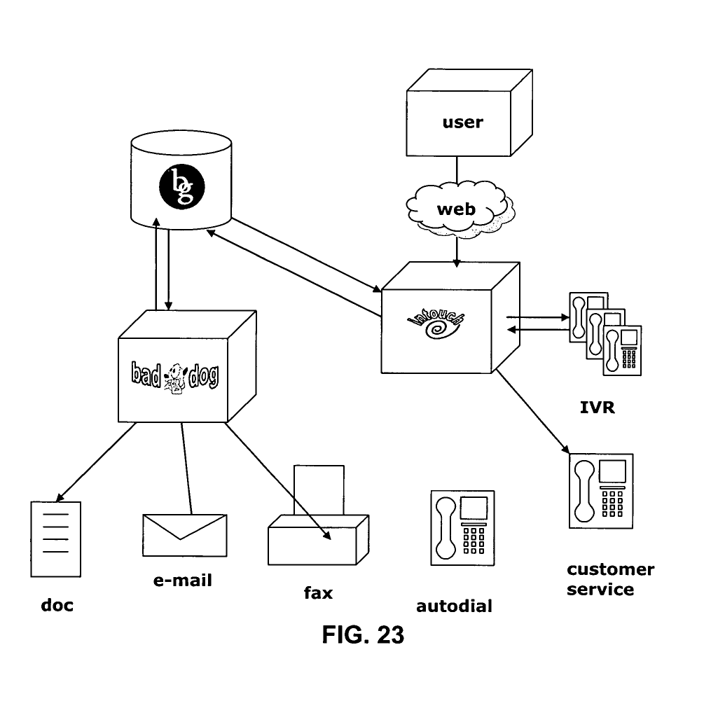

Links connect the user to the step-by-step process of qualification and education for each lead or consumer. A log maintains a list of time-stamped communications with the individual lead/potential consumer. The step-by-step process will be illustrated with the logic-flow diagram of FIG. 22. Counselors qualify, counsel, and educate leads, and can choose whether or not to enroll these leads in financial counseling services by using the process shown in FIG. 22. This process is divided functionally into steps that are designed to flow in accordance with an ideal counseling session. Initially personal information is obtained in step 222. Then the counselor will conduct a pre-qualification interview in Step 224. This allows debt options to be presented in step 226, a budget to be designed in step 228, further counsel and education in step 230. Additionally a presentation may be provided in steps 232 and 236 about amortization in step 234. Any application notes are written by the counselor in step 238. After which the application for the consumer is submitted in step 240. All the counseling and educational information provided within these steps can be configured to be tailored to a specific agency or message within a specific agency individual screens associating with the counseling module may be used to assist the counselor in gathering and discussing these steps.

Much like the leads management and consumer utilities, the process of offering additional counseling services begins with a search for consumers. The agency processor, using the continuing education utility in the customer service module creates entries for consumers who are seeking additional information. It then falls to the counselors at the agencies to provide the requested counseling and educational services.

The results returned from a search may include a list of all consumers who have requested additional counseling or education services, their status, their counselor and a link to more details about their specific requests. The counselor, or authorized user can make high-level changes to one or more consumer records from this screen, including a change to the consumer's status and a reassignment to a different counselor.

Accounting module 58 helps agencies and the agency processor manage payments and keep track of funds entering and leaving the system on a per-consumer basis. This ensures that all data which relates to a consumer's payment is kept in one unified data structure, and provides the next link in the chain of data from.

Using a payment/disbursement entry tool, either agency or processor accounting personnel can search for existing payments and/or add one or more conventional payment entries. Again, as in other search utilities throughout the system, searches can be carried out against a number of different criteria.

In addition to the entry of new payments, accounting module 58 may provide a mechanism for editing information related to previously entered payments.

A number of different payment methods including ACH (Automatic Clearing House) transactions are supported. Using accounting module 58, accounting personnel can schedule and submit ACH batches for ACH payments that have been authorized.

Accounting module 58 gives accounting personnel the ability to rapidly enter a Consumer's ACH Payment information, and/or search for previously entered information.

The system may accommodate multiple forms of payment including electronic payment and electronic payment disbursements. The infrastructure allows for the addition of any number of additional forms.

For the processing of payments made by consumers to a Debt Management Program (DMP), we refer to payment processing module 60. Consumers registering in a DMP with processor agency clients through the system have the option of submitting payments electronically, or through more traditional methods (check, Western Union, Money Order, etc.). The system is designed to handle all such methods, and to provide accurate and consistent reporting on the process and nature of payments submitted.

In order to maximize the rate of proposal acceptance, and to minimize the cost to the processor, its agency clients, and the consumers themselves, the system begins the processor of enrolling consumers with a request to the consumers' creditors for a verification of the stated balances. This happens electronically, and results in an adjusted balance, and electronically adjusted amounts (pending Consumer confirmation if necessary) in the proposal to be submitted.

Creditors review those debt management proposals submitted by the processor in a number of different formats, depending on the information required, on the creditor, and on the nature of benefits requested. The system is designed to submit DMP proposals electronically, and via paper through the U.S. Post.

Similar to proposal submission, creditors vary in their ability and mechanisms for accepting payments. Many smaller creditors can only accept payments in the form of printed paper checks. Larger creditors can accept electronic methods of payment. The system is designed to deliver both varieties. Funds may be dynamically allocated to the optimum creditor accounts, based on consumer balance, creditor policies and a number of other criteria. Having distributed the payments, the system makes data available for review by all appropriate users (users who are configured with the proper level of access) as well as by the consumer.

The principal purpose of call center module 62 is to provide a utility for customer service personnel at the processor, and/or at one of the processor's agency clients, to accept calls from consumers, access all relevant consumer information, generate actions based on the calls, and log all activity on the consumer's account. The elements of this interface include a consumer detail screen, from which the customer service representative can view all necessary consumer information, including contact information, payment details, creditor accounts, etc.

In order to efficiently process consumer requests, it is necessary for the customer service representatives (and other users of the system with varying levels of access) to have a mechanism whereby they can initiate tasks to be carried out by other users with differing access levels. All calls and requests for information are automatically logged with a background “history generation” process, but there is also a mechanism for the customer service representatives to pro-actively log each call and annotate exactly what was discussed and when. The annotation utility provides a list of pre-defined subjects that the CSR can choose from, making the process both simpler and more auditable. Often, requests for service or information involve actions which must occur at a later or recurring date. Using the scheduler/reminder utility, a user of the system can configure the system to generate reminders and/or carry out tasks on other days, or on a recurring basis.

As an essential mechanism for identification and automation, call center module 62 includes an automatic system for capturing customer information. The system cues the consumer and presents them with a list of options from which the consumer can choose by pressing buttons on their touch tone phones. Through this mechanism, the consumer can identify themselves and/or complete the request for service themselves.

If additional support is required, a customer service representative (“CSR”) is then identified and prompted by the system with a notification identifying the consumer and providing any required information so that the consumer need not repeat their submission, and the CSR can begin from an informed position.

In addition to the general mechanisms described above, call center module 62 may have a host of specific utilities designed to automate and facilitate common tasks.

When calling for customer service, consumers may also have additional questions concerning supplemental topics of financial and credit counseling. With the continuing education utility, a customer service representative can register the request for more information, and the request will then be forwarded to counselor module where agency counselors can access it and respond.

The system allows for any number of users and a varying degree of access levels. Using supervisor module 64, users who are designated as supervisors, with control over accesses and permissions, can add, deactivate, and edit information about users of the system.

Users with appropriate access can adjust the settings for all users who operate within the system with a lower level of access. To perform such operations on users who are currently configured to use the system, the first step is the Search function. Here again, the user has multiple search criteria from which to choose.

The search results include a summarized view of the main aspects of a users account (their email address, user ID, type of access, and title). As well as controls for resetting passwords and configuring a user to be able to accept lead assignment (see the lead management tool in the counselor module). There is also a link which results in the presentation of the edit screen (which allows someone to edit more details about a given user.)

Users are configured to use the system through the add user utility. This is a fairly self-explanatory feature which allows a users with appropriate access to assign access permissions (within a range of permissions that are less far-reaching than those of the user's own access) to other system users.

The present invention provides multiple interfaces. A consumer interface allows consumers to register themselves directly from the Internet. The process involves an initial registration—which provides consumers with access to some diagnostic tools and budget calculators. Following the initial registration, the consumer is prompted to enroll in a debt management program. This process culminates in a complete consumer application (pending counselor validation). Throughout the process, the consumer is prompted to continue with the XML-based communication.

The processors interface allows processors to manage and maintain all portions of the consumers account. Tools within this interface facilitate management of universal data, which applies to all users—specifically (shown here) the creditor database. The processor Web interface may also have a corresponding identical desktop-installed interface. Providing both formats ensures guaranteed access, irrespective of place and technological resources.

An agency interface, allows agency administrators to automate the process of distributing “Leads.” Leads are consumers who could potentially be enrolled and benefit from a debt management program. “Leads” are distributed in accordance with an algorithm, which matches “Lead” debt load with counselor skill-set. A counselor interface allows counselors to move from “Lead” to “Lead” within their assigned pool, collecting more information from each “Lead” and communicating with the “Lead” and distributing application information via an XML-based communication engine. “Leads” become “Consumer” status in the final step of processing.

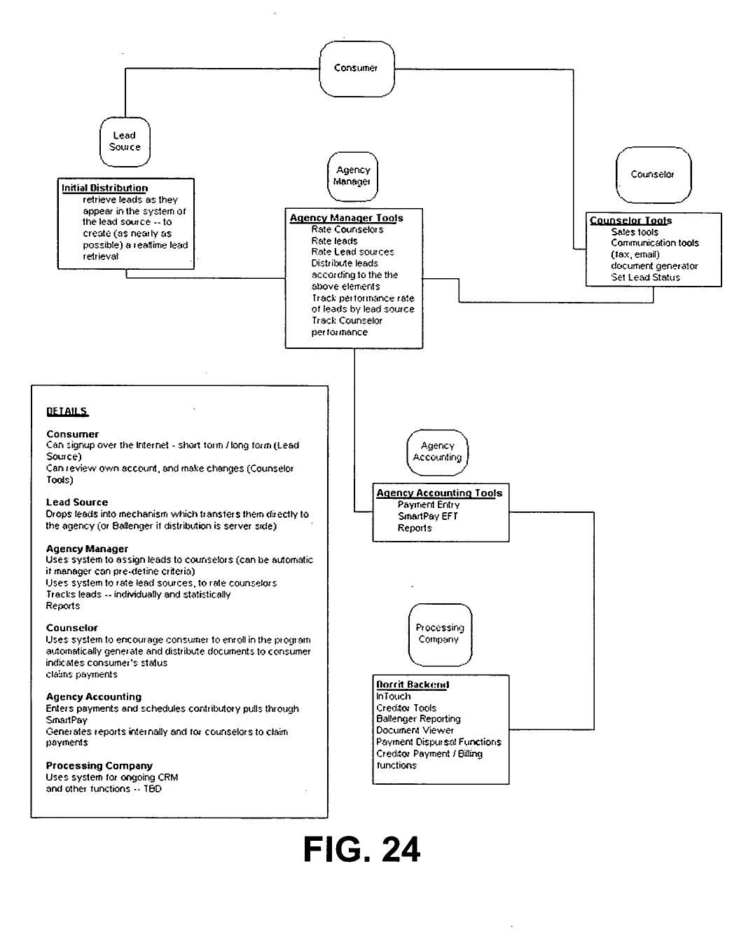

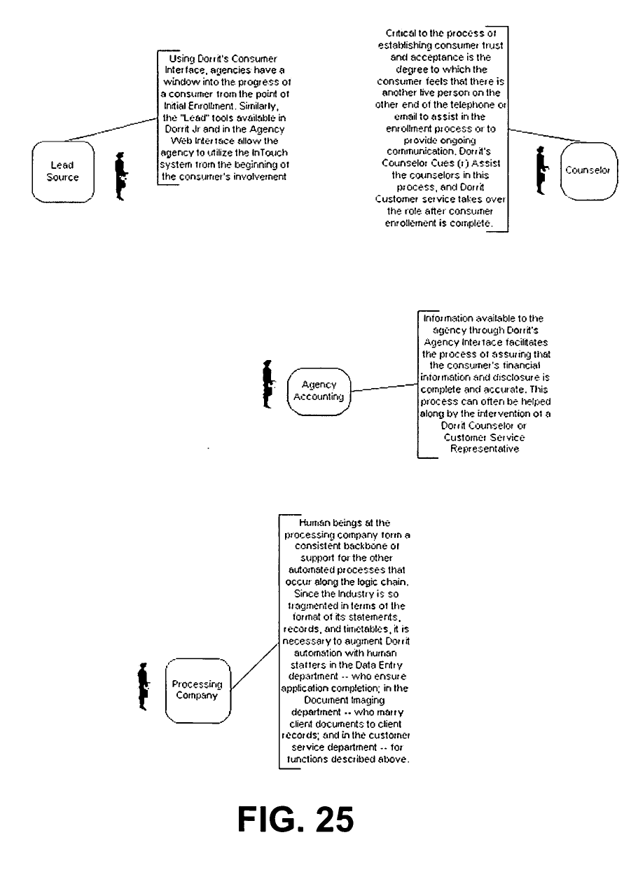

FIG. 24 provides a general overview of this disclosure system and illustrates how consistency of data is maintained throughout the lifecycle of consumer involvement. FIG. 24 depicts how data is managed by the software application taught within the instant disclosure. Here, data from lead sources is provided by marketing companies which identify various lead sources and provide contact information associated with an individual lead as part of a proprietary formatted data sat or database. Once identified, the software application identifies leads and routes them to the proper counselors wherein the consumer's needs are matched with the counselor's skills. This matching is based on criteria determined by the agency managers, which are controlled via the agency manager tools interface depicted at the heart of FIG. 24.

As we can see, with respect to the agency manager tools, the initial distribution from the lead source is provided to the agency manager wherein the agency manager uses tools to rate the counselors and the leads and the lead sources and then to distribute the leads according to the above criteria. Then it is possible to track the performance rate of leads by either the source or the counselor or the criteria or any combination of the above criteria. When the lead is provided to the counselor, the counselor uses their provided set of tools to contact or communicate with the potential consumer whether it be via fax, email, or phone, or postal mail. This communication hopefully allows the consumer to be contacted and be promoted from a lead to a consumer.

Once a lead has been promoted to a consumer, it is the responsibility of the agency to validate that all of the proper information is correctly collected and formatted from the consumer. This allows the consumer to properly enroll in a debit management program. Once they have been validated, a payment system or arrangement is established between the consumer and the counselor or agency to then track the consumer. The consumer is then transferred to the processing portion of the instant application.

The human data processing portion validates the information provided by the consumer. The agency manager tools allow the debt management proposals to be sent to the creditors via the processing company. These creditor tools allow the agency to bundle a large number of proposals into one negotiated agreement. This proposal includes the current balances, the account numbers, and the payment information, to which the creditors will respond with a favorable or unfavorable reply. As to whether or not to accept this client into a debt management program. This debt management program may result in reduced interest rate, reducing the principal balance or reducing the payments themselves. The present invention maintains a history of data associated with the initial lead source to the approved debt management program, as well as the future execution of that debt management program. This in itself provides a significant advantage in that it tracks a lead to its initial source through the execution of the debt management program.

A creditor is more likely to accept a proposal from a large bundled number of debtors given the fact that a certain percentage will make the payments. Therefore the creditor does not have to individually negotiate with individual clients. In the case where people are paying electronically, their accounts are automatically debited for the appropriate amount and the funds are electronically transferred. For people paying with checks, a combination of automatic images the checks to track all the actual documents received from the client. The checks are then disbursed to the creditors by the agency on an ongoing basis. At any given time, the agency can go to the creditor and then report to them the number of leads they receive, the number of leads that actually become consumers and whether or not the consumers actually execute a debt management program. Additionally, it is possible to track how effective the communications to the individual consumers are, whether by varying the timing associated with communications to individual consumers or what the net effect on that variation in timing is on the actual realization of payments from the consumers.

FIG. 25 provides a general schematic that indicates various points where human intervention compliments automation.

The disclosed operations involve multiple simultaneous deployments of various Internet Interfaces, as well as desktop tools at the agency level and the processor level, and human operatives. Human intervention represents a significant technical advantage over existing-automated systems, since human operatives can be relied upon to make decisions far superior to that of any automated system. Operating in concert, these various systems combine to channel consumer information through a single conduit of data flow, which forces data consistency and integrity and are one of the principle technical advantages to the system.

In the disclosed system all consumer data passes through the same conduit. This ensures that information is always available regarding every stage of the consumers' financial development. This allows the system to provide valuable industry and consumer-specific insight to counseling agencies, creditors, and processing companies. Data consistency is accomplished by establishing a single central (redundant) node into which all consumer-related data passes.

Another principal technical advantage stems from the supplemental human intervention endemic to the disclosed system. Each automated element of the system is buttressed by an accompanying human interface, or process of human validation.

Yet another principal technical advantage is interface redundancy, which ensures ease of use of the system across platforms and technical resources. By providing a paired Internet interface to every available desktop interface, a toolset for manipulation of every process along the data chain can be provided at all times through a variety of interfaces.

Although the present invention is described in detail it should be understood that various changes, substitutions and alterations can be made hereto without departing from the spirit and scope of the invention as described by the appended claims.

1. A method to manage consumer's financial development, comprising:
constructing a consumer's financial profile for an individual consumer, wherein the consumer's financial profile is maintained within a consumer database;
creating a lead based on the consumer's financial profile, wherein the lead is provided to at least one counselor, and wherein the at least one counselor is operable to establish a relationship with the individual consumer;
determining financial options available to the individual consumer based on the consumer's financial profile and communications between the at least one counselor and the individual consumer;
selecting a financial program from the financial options available to the individual consumer based on the consumer's financial profile; and
submitting a financial application for the selected financial program for approval.

2. The method of claim 1, wherein the consumer's financial profile is constructed with a web-based consumer interface presented by a consumer module.

3. The method of claim 2, wherein the lead is created with an initial financial profile for the individual consumer, and wherein the lead is distributed to at least one counselor by a lead sourcing module.

4. The method of claim 3, wherein a counselor module facilitates communication within the relationship between the at least one counselor and the individual consumer.

5. The method of claim 1, further comprising executing the selected financial program.

6. The method of claim 5, wherein an accounting module and processing module facilitate executing the selected financial program.

7. The method of claim 6, wherein a web-based consumer interface presented by a consumer module allows the individual consumer to track the executed selected financial programs progress.

8. The method of claim 7, wherein the consumer module, accounting module, processing module, a lead sourcing module, a counselor module, and a creditor module and executed within a networked computer system accessible to users through a web-based interface.

9. A network based system to facilitate managing a consumer's financial development, comprising:
a network based computer, operable to execute a:
a consumer module;
a communication module;
a lead sourcing module;
a creditor module;
a financial processing module; and
a counselor module;
a consumer database operably coupled to the network based computer;
a creditor database operably coupled to the network based computer;
a lead database operably coupled to the network based computer; and
wherein consumers, counselors and creditors may interact with one another through web-based user interfaces presented by modules executed on the network based computer.

10. The network based system of claim 9, wherein the consumer module is operable to construct a consumer profile for an individual consumer, wherein the consumer profile is maintained within the consumer database.

11. The network based system of claim 10, wherein leads are created based on the consumer profile, wherein the lead is provided to at least one counselor by the lead sourcing module, and wherein the at least one counselor is operable to establish a relationship with the individual consumer.

12. The network based system of claim 10, wherein the at least one counselor may determine financial options available to the individual consumer based on the consumer profile and communications between the at least one counselor and the individual consumer.

13. The network based system of claim 9, wherein the counselor module is further operable to:
select a financial program from the financial options available to the individual consumer based on the consumer profile; and
submit a financial application for the selected financial program for approval.

14. The network based system of claim 13, wherein a counselor module and communication module facilitate communication within the relationship between the at least one counselor and the individual consumer.

15. The network based system of claim 14, wherein the financial processing module further comprises:
an accounting module; and
a processing module, wherein the financial processing module is operable to facilitate executing the selected financial program.

16. The network based system of claim 15, wherein a web-based consumer interface presented by the consumer module allows the individual consumer to track the executed selected financial programs progress.

17. The network based system of claim 15, wherein the consumer may enroll within a plurality of financial programs throughout the consumer's financial development with information maintained within the consumer profile.

18. The network based system of claim 15, wherein the communication module gathers failed communication attempts to the consumer and issues a request to the consumer to update their consumer profile maintained within the consumer database.

19. The network based system of claim 18, wherein the request to the consumer to update their consumer profile may be sent via an alternative communication pathway.

20. The network based system of claim 19, wherein the alternative communication pathway may be a communication pathway selected from the group consisting of telephone communications; facsimile communications; hard copy communications; and electronic communications.
